(19) United States
(12) Patent Application Publication
(10) Pub. No.: US 2011/0022580 A1
(43) Pub. Date: Jan. 27, 2011

(54) EXCHANGE OF SERVICE CAPABILITIES IN COMMUNICATION NETWORKS

(75) Inventors: Cristina Badulescu, Roxboro (CA); Guillermo Saavedra, Montreal (CA)

Correspondence Address: ERICSSON CANADA INC.;PATENT DEPARTMENT, 8400 DECARIE BLVD., TOWN MOUNT ROYAL, QC, H4P 2N2, CA

(73) Assignee: TELEFONAKTIEBOLAGET LM ERICSSON (PUBL), Stockholm (SE)

(21) Appl. No.: 12/506,931

(22) Filed: Jul. 21, 2009

(51) Int. Cl. G06F 17/30

(52) U.S. Cl. 707/712; 707/E17.001

(57) ABSTRACT

Systems and methods according to these exemplary embodiments provide for optimizing network resource usage and facilitating exchange of user capabilities information. This can occur by creating a view which shows all of the methods or services which are available for contacting a particular user, which information is viewable by other users of the network. This then improves communications by reducing the potential for one user to attempt to communicate with another user via a method which a user does not support.

### TECHNICAL FIELD

The present invention relates generally to communications and in particular to methods, devices and systems involving exchange of service capabilities information.

### BACKGROUND

During the past years, the interest in using mobile and landline/wireline computing devices in day-to-day communications has increased. Desktop computers, workstations, and other wireline computers currently allow users to communicate, for example, via e-mail, video conferencing, and instant messaging (IM). Mobile devices, for example, mobile telephones, handheld computers, personal digital assistants (PDAs), etc., also allow the users to communicate via e-mail, video conferencing, IM, and the like. Mobile telephones have conventionally served as voice communication devices, but through technological advancements they have recently proved to be effective devices for communicating data, graphics, etc. Wireless and landline technologies continue to merge into a more unified communication system, as user demand for seamless communications across different platforms increases.

Many communication applications allow for real-time or near real-time communication that falls outside of the traditional voice communication associated with wireline and wireless telephone communications. Chat session, instant messaging, Short Message Service (SMS), video conferencing, are a few such communication vehicles. Many of these types of communications are expected to become increasingly popular, particularly in view of the proliferation of wireless devices and continual technological breakthroughs in this area. However, issues are still to be solved to enhance growth of certain services.

For example, regarding service related technologies promulgated by Open Mobile Alliance (OMA) and used by the Global System for Mobile communication Alliance (GSMA) Rich Communication Suite (RCS) operators are looking for ways to provide their users with information related to other users' service capabilities, whether a presence relationship (or similar, existing trust/friendship schema) between such users exists or not. Operators view the provision of service capabilities information exchange between users as a potentially significant growth enhancer which will motivate users to communicate with other users through services they have in common, which cannot happen if a user does not know what services another user can be contacted through.

Two partial solutions have been presented for informing other users of a user's service capabilities. One partial solution, described in the OMA presence specification, provides an indication of the service capabilities that a user has available to him or her on a specific device that he or she is currently using, i.e., which may however constitute only a subset of the overall service capabilities that the user has subscribed to. Additionally, the OMA presence specification requires that a presence relationship be established between users as a prerequisite to passing on the services published by each device with the presence data. To establish this presence relationship, a user, e.g., the so-called “watcher” in presence terminology, has to subscribe to another user's presence information and the latter has to accept this subscription request. Then, as soon as presence status is published by one of the user's devices, the particular device's service capabilities are published with the presence status and become available to the watcher. However, a presence relationship typically implies a closer human relationship between the users, which is not always the case between people that wish to know how to contact each other. Moreover, this partial solution does not guarantee exchange of all of a user's service capability information since it is centric to the particular device via which a user is currently connected to the network.

Another partial solution which has been discussed relates to GSMA RCS where a peer-to-peer exchange of device capabilities is possible using Session Initiation Protocol (SIP) OPTIONS. Similar to the OMA presence partial solution described above, the service information is specific to the device exchanging the SIP OPTIONS message and does not reveal the entire set of services that the user has subscribed to and is capable of using in communication with other users. Moreover, using the SIP OPTIONS message, if the user changes devices, a new SIP OPTIONS exchange needs to occur. Additionally, a limitation associated with both of these partial solutions is that the service capabilities “published” by a user to other users watching his or her information are limited to the specific device that publishes this data, rather than offering to the entire set of services of that user regardless of the device in use at one specific point in time.

Accordingly, systems and methods for informing users about service capabilities in a more flexible and efficient manner is desirable.

### SUMMARY

Exemplary embodiments relate to systems and methods for improving communications between users in a network (or networks). According to exemplary embodiments, it is desirable to enable exchange of service capabilities information regarding all of the methods or services by which a user can be contacted for other users to see, e.g., selectively based upon the publishing user's authorization. Advantages according to exemplary embodiments include optimizing the usage of network resources and motivating users to use existing services by identifying others that have such services. Moreover, exemplary embodiments also allow a first user to decide which other users will see that first user's user service capabilities. However, it will be appreciated by those skilled in the art that such advantages are not to be construed as limitations of the present invention except to the extent that they are explicitly recited in one or more of the appended claims.

According to an exemplary embodiment a Converged Address Book (CAB) network node includes at least one processor configured to execute a CAB application and at least one memory device connected to the at least one processor and configured to store CAB Personal Contact Cards (PCCs). Each PCC is associated with a different user and has a plurality of Contact Views associated therewith. One of said Contact Views lists user service capabilities (USCs).

According to another exemplary embodiment a method for exchanging service capabilities in a communication network includes the step of transmitting, from a network node, user service capabilities (USC) information. The USC information indicates those services that are available in said communication network via which a first user can be contacted by other users.

According to another exemplary embodiment, a method for providing Converged Address Book (CAB) information to users of a communications network includes storing a plurality of Personal Contact Cards (PCC), each PCC being associated with a different user and having a plurality of Contact Views associated therewith. One of the Contact Views lists user service capabilities (USCs). The USCs are then transmitted to users, e.g., those users who have subscribed to a CAB service and who are authorized by the user corresponding to a particular PCC to receive that users USC information.

### BRIEF DESCRIPTION OF THE DRAWINGS

The accompanying drawings illustrate exemplary embodiments, wherein:

FIG. 1 depicts a communication system according to exemplary embodiments;

FIG. 2 shows communications with an address book server/entity according to exemplary embodiments;

FIG. 3 illustrates communication with a Converged Address Book (CAB) according to exemplary embodiments;

FIG. 4 depicts Contact Views within a CAB Personal Contact Card (PCC) eXtensible Markup Language Data Management Server (XDMS) according to exemplary embodiments;

FIG. 5 shows a communications node according to exemplary embodiments; and

FIGS. 6 and 7 show method flowcharts for exchanging user service capability information according to exemplary embodiments.

### DETAILED DESCRIPTION

The following detailed description of the exemplary embodiments refers to the accompanying drawings. The same reference numbers in different drawings identify the same or similar elements. Also, the following detailed description does not limit the invention. Instead, the scope of the invention is defined by the appended claims.

According to exemplary embodiments, it is desirable to provide to users, or to enable other users to access, service capabilities information for a particular user. To more readily differentiate various sets of service capabilities in this document, two phrases which will be used in this specification will now be described. The phrase “Device Services Capabilities” (DSC) as used herein refers to the subset of services to which a user has subscribed and/or via which that user can be contacted, but which are supported by a particular device, e.g., a device via which the user is currently connected to a network. Thus, DSC identify capabilities in a device dependent manner. On the other hand, the phrase “User Service Capabilities” (USC) as used herein describes the entire set of services, as available for example in either the Home Subscriber Server (HSS) or the Home Location Register (HLR), through which a user may be contacted and/or to which the user has subscribed. That is, the USC identifies the complete set of services independently of any given device which a user may be using.

A network address book service provides the contact information of other users to the owner or user of the address book. The information stored in the network address book is generally relatively static, i.e., the stored information is not expected to change often, as compared to dynamic information which is expected to change at any time. For example, such relatively static, network address book information can include Versitcard (vCard) type information including a contact's routable address in one or more forms (e.g., telephone number, email address, etc.) that can be used to establish communications between users. According to exemplary embodiments, the USC data can be stored in a network address book to show the full set of contact methods or services associated with a particular user and be further relayed to the user's device as part of the address book data. Moreover, the addition of the USC data to the network address book according to these exemplary embodiments provide network operators with a streamlined method for allowing users access to a full set of service capability information without, for example, requiring an accepted presence relationship and while also avoiding loading the network with exchanges of DSCs for every device. Another advantage is that the user can establish authorization rules for the read access of the USC data specifically and independently of any other information (Contact View, presence information, etc). Thus other authorized users would be able to obtain the first user's USC, even if they are denied a presence relationship or any other PCC Contact Views access.

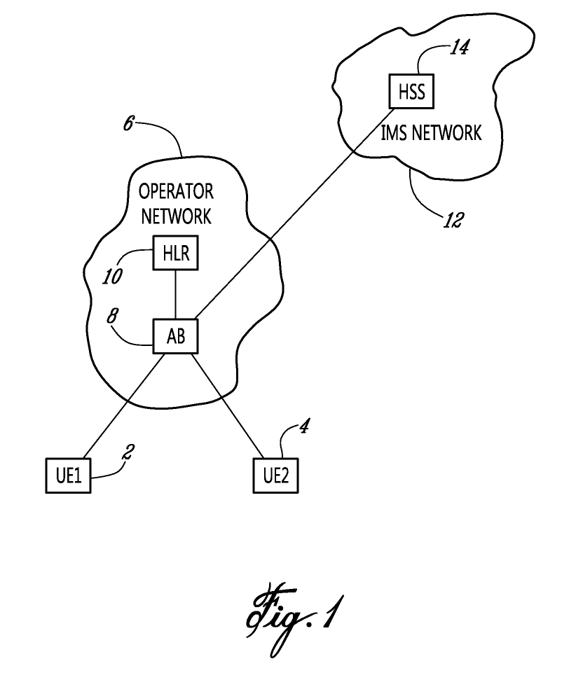

Prior to describing exemplary embodiments which use a network address book for storing USC information, an exemplary (and simplified) communications system in which the address book can reside and provide such USC information will now be described with respect to FIG. 1. Initially, user equipments UE1 2 and UE2 4 are in communications with an address book (AB) 8 located in operator network 6, e.g., a software entity operating on an application server node in the network 6. As will be described in more detail below, the AB 8 illustrated in FIG. 1 conceptually represents the address book that is shown (e.g., provided by a Converged Address Book (CAB)) to the user and which contains the USC within the data of each Contact Entry of the Address Book. Operator network 6 also includes an HLR 10, which is a database that includes subscriber information for a mobile network. HLR 10 and the AB 8 have an interface over which they can communicate. AB 8 also has an interface over which it can communicate with an HSS 14 located within an Internet Multimedia Subsystem (IMS) network 12. HSS 14 is a database which handles subscriber information for an IMS network 12. According to exemplary embodiments, both the HLR 10 and the HSS 14 can store user information which can be retrieved and stored by the AB 8. Additionally, more nodes, fewer nodes or different network configurations can be used, e.g., the AB 8 could be located in a network which does not include the HLR 10. Also it will be appreciated by those skilled in the art that, typically, the UEs 2 and 4 will be connected to the network 6 and the AB 8 through access points, such as base stations or eNodeBs in a wireless network, and other intervening nodes which are not shown in FIG. 1 to simplify the description.

According to one exemplary embodiment, the AB 8 can be a Converged Address book (CAB) application. The CAB application can provide updated contact information regarding a user by keeping the CAB up to date with the latest published information by the contacts themselves. The user's own contact information being published is called a Personal Contact Card (PCC) in this exemplary embodiment and can be structured with different Contact Views that relate to the user's different interests and relationships, e.g., home, work, gaming, social networks, etc. This data may be based upon vCard content, however USC data is not traditionally available via vCard format. According to exemplary embodiments, a user's USC information can be included as a separate Contact View as part of the user's Personal Contact Card.

The different Contact Views stored on the Personal Contact Card can be made available to other users based on subscription requests that are authorized by the user owning the PCC. Every user can choose the users, or lists of users, that she or he authorizes to obtain the different Contact Views within their Personal Contact Card. A user's USC information can be stored as its own Contact View, e.g., a Service Capability Contact View, and can thus be authorized for publication or access to users independently of, or together with, authorization for the other Contact Views of a user's Personal Contact Card. The USC information can be obtained by the CAB from either the HSS 14 or the HLR 10 in this exemplary embodiment.

According to some exemplary embodiments, the USC data obtained by the CAB is “folksonomized” prior to being stored in the Service Capability Contact View. As used herein, the term “folksonomized” refers to translating service capabilities as they are stored in their source format, e.g., in the HLR 10 or HSS 14, into other terms or formats that can be more readily understood by the everyday user. Stated differently a folksonomy process applied on the USC information according to some exemplary embodiments means that a specific network service is mapped, categorized and stored under its more popular naming, e.g., an instant messaging (IM) service provisioned in the HSS 14 can be mapped into the Service Capability Contact View as “instant messaging” or “chat”, while the Presence IFC from the HSS 14 can be translated into “presence”, etc. Such a translation or folksonomization process enables the subsequently distributed USC information to be more readily understood by the end users.

To better understand USC information exchange according to this exemplary embodiment, an exemplary exchange will now be described. For example, consider two users, Alice and Bob. Alice has Bob in her address book, e.g., a CAB, and she subscribed to Bob's Personal Contact Card updates. Bob has authorized Alice to obtain updates to two of his Contact Views, e.g., Work Contact View and Social Contact View, that he has defined in his Personal Contact Card. Every time Bob performs a change in the data fields associated with these two Contact Views, Alice can see them updated in her own address book. In this example, Bob has registered for the following services with his service provider: video messaging, voice, chat and text messaging. All of those services are provisioned in the operator's HSS 14 or HLR 10, as applicable. According to exemplary embodiments of the present invention, Bob's Personal Contact Card information now includes a new Contact View, i.e., the Service Capabilities Contact View, which Contact View will contain information which these identifies these three services. As Bob wants Alice to see his service capabilities, so that she can successfully choose her method of communication with Bob, he sets the authorization rules to allow Alice to be updated with his Service Capabilities Contact View as well according to this exemplary embodiment. Thus, when Alice accesses Bob's page or the entry in her address book containing Bob's contact information, using any of her devices, e.g., cell phone, personal computer, PDA, etc., she will be able to see that Bob has access to video messaging, voice, chat and text messaging services (e.g., by way of representative icons in Bob's address page or Vcard or other simple User Interface representations) and will know about all of the services to which Bob has access irrespective of any particular device that Bob may be connected to the network with at any given time.

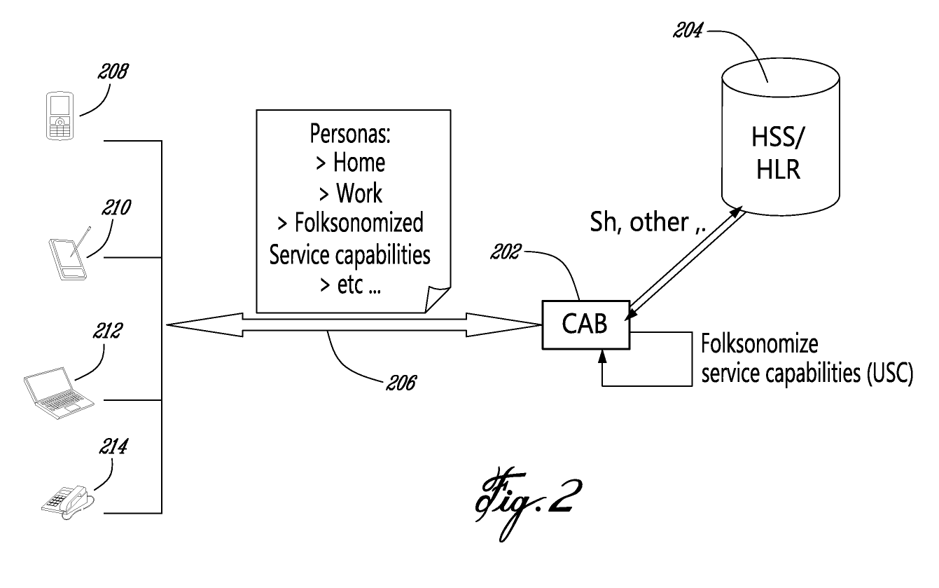

According to exemplary embodiments, an address book application, e.g., a CAB 202, can, as shown in FIG. 2, retrieve the latest services that a user is provisioned with from a data repository or database, e.g., the HSS/HLR 204, and update them in his or her Personal Contact Card. The CAB 202 can use various methods to retrieve this information from the data repository 204 and, therefore, the CAB 202 needs to have an interface with the appropriate data repository which stores information about subscribed services on a per user basis, e.g., the HSS/HLR 204, (which entity and interface will thus depend upon the particular system implementation) in order to fetch the user's provisioned services. For example, the interface used between the CAB 202 and the HSS is the Diameter based Sh interface. It will be appreciated by those skilled in the art that the mechanism by which information is provided from the HSS/HLR 204 to the CAB 202 according to this exemplary embodiment can be a pull or push mechanism. The CAB 202 can keep track of the new Contact View Service Capabilities on the user's Personal Contact Card where it will keep up to date a folksonomized copy of the USC data for that user from the HSS/HLR 204 profile. The user then controls whom he or she wants to allow to obtain updates of their Service Capabilities Contact View by, for example, setting up the authorization rules for this Contact View and/or listing the users or domains that are allowed to see the Service Capabilities Contact View. The CAB 202 can then relay the folksonomized USC information as shown by communications arrow 206 to the various authorized users represented by the various communication devices 208, 210, 212 and 214.

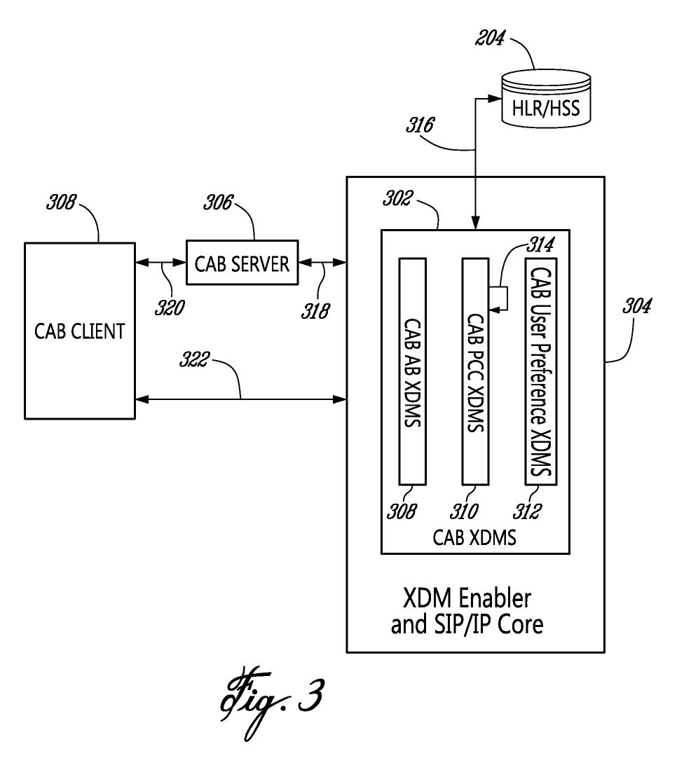

The present invention is generic to the type of address book application or implementation which is used in a given network. However, as mentioned above, one specific type of address book implementation which is contemplated according to an exemplary embodiment is a Converged Address Book (CAB) as used in OMA specified systems and in accordance with the OMA standard, except as modified herein. FIG. 3 shows an exemplary architecture including CAB 304 and support nodes which can interact with the CAB 304 according to this exemplary embodiment. The CAB 304 can include a CAB eXtensible Markup Language Data Management Server (XDMS) 302 which can, for example, reside in an eXtensible Markup Language Data Management (XDM) Enabler running on a SIP/IP Core network node. The CAB XDMS 302 according to this exemplary embodiment includes a CAB AB XDMS 308, a CAB Personal Contact Card (PCC) XDMS 310, folksonomizing logic 314 and a CAB User Preference XDMS 312. According to this exemplary embodiment, the CAB 304 is in communications with the CAB Server 306 over interface 318. Interface 318 can represent any (or all) of the interfaces which can be used between the CAB Server 306 and the CAB 304, e.g., SIC-2, XDM-4i and XDM-7i interfaces. Note, however, that CAB 304 and CAB Server 306 can, alternatively, be implemented as a single node.

The CAB Server 306 is also in communications with the CAB Client 308 over interface 320 which represents any (or all) of the OMA standardized interfaces used between the CAB Server 306 and the CAB Client 308, e.g., the CAB-1 interface. The CAB Client 308 represents an application running on a UE, e.g., a mobile phone with software acting as a CAB Client. CAB Client 308 is in communications with the CAB 304 over interface 322 which represents any (or all) of the interfaces which can be used between the CAB 304 and the CAB Client 308, e.g., SIC-1, XDM-3i, XDM-5i and XDM-non-SIP interfaces. CAB 304 additionally has an interface between the CAB PCC XDMS 310 and the HLR/HSS 204 (which entity and which interface depend upon the particular system implementation of interest) for retrieving services information. Exemplary usages of the architecture shown in FIG. 3 for providing user service capability information will now be described.

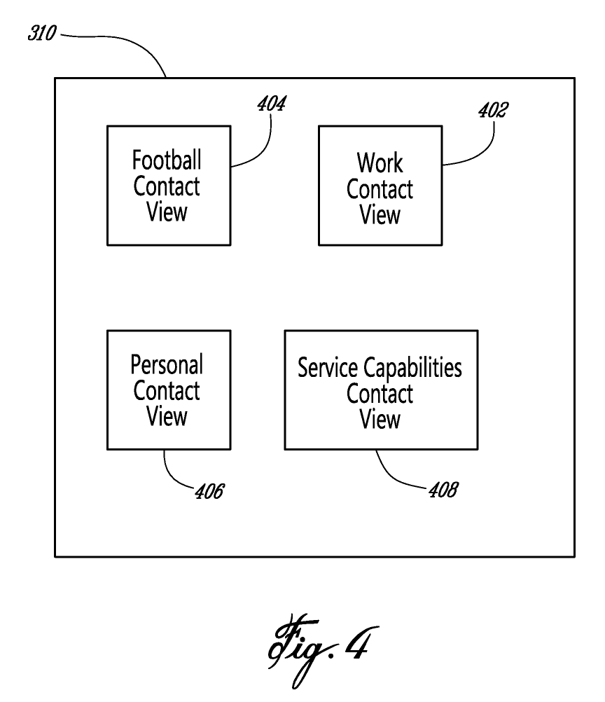

According to exemplary embodiments, the enabler within CAB 304 can allow a service provider to provide a set of Contact Views, each with their associated default set of fields, for use and personalization by each CAB User, potentially subject to service provider policies. Contact Views can be defined by the service provider or, in some cases, by the user. When defined by a service provider, such Contact Views can provide additional information related to a CAB user's contacts. This extra information can be used to enable/enhance communication, e.g., to improve the rate of success for the various communications initiated. In order for an end user to view/display Contact Views on his or her UE, information is transmitted between the CAB Client 308 and the CAB 304 through the CAB Server 306. This information is typically transparent to the CAB Server 306. According to exemplary embodiments, a CAB user's Contact Views are stored in the CAB PCC XDMS 310 as shown in a graphical, yet purely illustrative example, in FIG. 4.

FIG. 4 shows four exemplary Service Contacts: (1) Work Contact View 402, (2) Football Contact View 404, (3) Personal Contact View 406 and (4) Service Capabilities Contact View 408. In this exemplary embodiment, consider that the CAB user has defined the first three Contact Views 402, 404 and 406 and the service provider has defined the Service Capabilities Contact View 408. Service Capabilities Contact View 408 includes the complete set of the services for which a CAB user has a valid subscription and through which other users can contact him or her, i.e., the USC information as described above.

According to exemplary embodiments, as described above, the CAB PCC XDMS 310 can be organized into multiple Contact Views that are controlled by the CAB User. Additionally, the service provider can also offer the CAB User some predefined Contact Views that the CAB User can decide to use (or not) and for which the CAB User will also define some authorization rules, e.g., to determine what information other users may view via their address book clients on their user equipments. The service provider also holds information about the totality of a CAB user's services to which he or she has subscribed and/or is allowed to use in his or her network, e.g., voice, video, telephony, IM, chat, Converged IP Messaging (CPM), residential, etc.

To populate the Service Capabilities Contact View 408 in the CAB PCC XDMS 310 when a new user is provisioned in CAB, according to exemplary embodiments, information about all of the a user's services can be queried by the CAB PCC XDMS 310 and be pre-populated in the CAB User's Service Capability Contact View 408. The CAB User can then define the authorization rules that will provide the list of users (or groups of users) allowed to see the Service Capability Contact View 408. After receiving the services list, and optionally prior to storing it, the services are folksonomized by instructions 314 (in, for example, the same manner as was described above with respect to the exemplary embodiment associated with FIG. 2) so that all of the services are translated into terms understood by the average user, e.g., CPM is folksonomized as “chat”, “instant message”, “video session”, etc. This folksonomized version is then stored and displayed for other users, as allowed, to view.

According to exemplary embodiments, all users that subscribe to the CAB User's PCC updates, and are also authorized by the CAB User to see his or her Service Capability Contact View, will be able to see which services they can use to contact that CAB User. The contacts in the address book will also be shown to a user with the exact set of services that can be used to contact or communicate with each of them. Additionally, according to exemplary embodiments, the CAB PCC data can be stored in any desired format after folksonomization in new, additional data fields which are provided in the Contact View for this purpose. For example, relatively simple fields can be used with service element attributes, such as, name and value. An exemplary schema is shown below.

```
<service name = “video calls”>
  <value = “true”/>
</service>
<service name = “chat”>
  <value = “true”/>
</service>
<service name = “presence”>
  <value = “true”/>
</service>
```

However, it will be appreciated by those skilled in the art that the foregoing schema is purely illustrative of the data formats which can be used and that other formats may be used instead.

According to exemplary embodiments, a CAB user can change their subscription information with their service provider. This in turn can lead to a change of the information which needs to be stored in the Service Capabilities Contact View. According to other exemplary embodiments, when using a CAB 204 in an IMS environment with, e.g., IMS enablers, additional supporting information for choosing the communications option is provided. For example, when a user chooses a specific contact method for communicating a message, e.g., a video communication, to another user, the system, when in an IMS environment, can route the communication request to the appropriate terminal, making the choice of choosing the contact method transparent to the originating user.

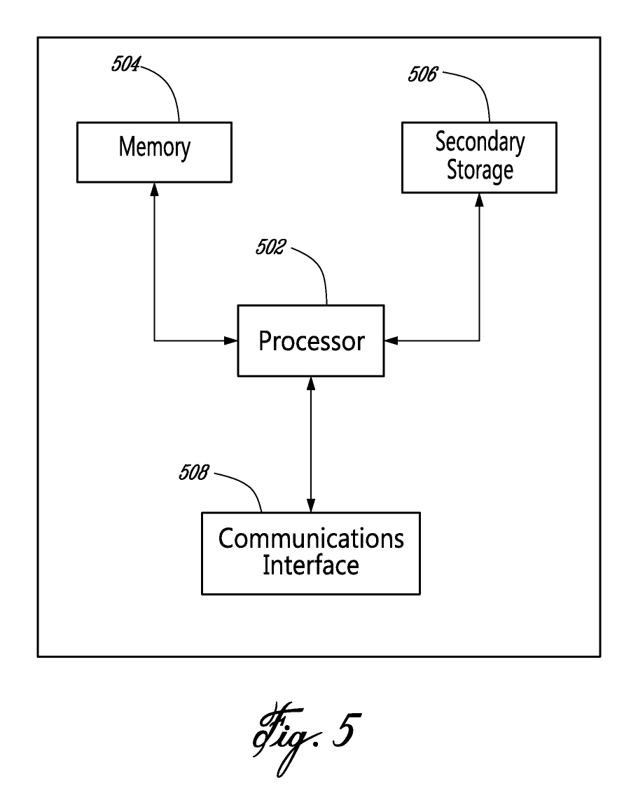

The exemplary embodiments described above provide methods and systems for making the user service capabilities which are available for communicating with a particular user readily available to other user. Such techniques can be implemented within network communications nodes which execute address book applications. For example, as shown in FIG. 5, communications node 500 can contain a processor 502 (or multiple processor cores), memory 504, one or more secondary storage devices 506 and a communications interface 508. Communications interface 508 is configured to be able to interface with the HLR/HSS 204 (which entity and which interface depend upon the type of system implementation). Communications node 500 is capable of processing instructions to folksonomize information and then storing the folksonomized information in support of performing the duties of any (or all) of the functions associated with the AB 8, e.g., the CAB 202, 304. Additionally, the communications node 500 can include software instructions, e.g., application software, which would allow it to perform the functions of a CAB Client 308 or a CAB Server 306.

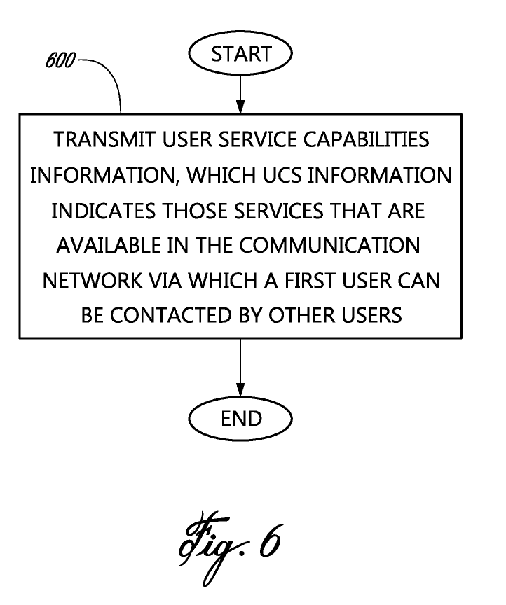

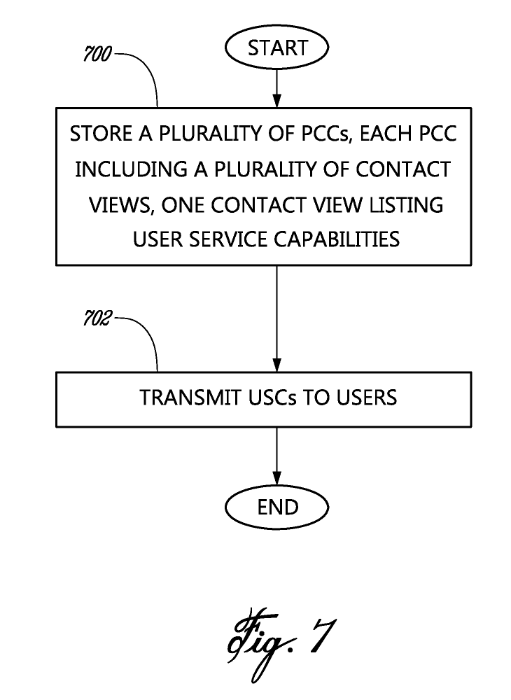

Utilizing the above-described exemplary techniques, and according to an exemplary embodiment, a method for exchanging service capabilities in a communication network can be described as illustrated in the flowchart of FIG. 6. Therein, at step 600, a network node transmits user service capabilities (USC) information, which USC information indicates those services that are available in a communication network via which a first user can be contacted by other users. According to another exemplary embodiment, a method for providing Converged Address Book (CAB) information to users of a communications network includes the steps illustrated in FIG. 7. Therein, at step 700, a plurality of Personal Contact Cards (PCC) are stored, each PCC being associated with a different user and having a plurality of Contact Views associated therewith. One of the Contact Views lists user service capabilities (USCs). The USCs are then transmitted to users at step 702, e.g., those users who have subscribed to a CAB service and who are authorized by the user corresponding to a particular PCC to receive that users USC information.

It will be appreciated by those skilled in the art that these exemplary embodiments provide an automated mechanism for learning about a user's service capabilities regardless of whether that user is currently connected to the network or, if the user is connected, regardless of which device that user is currently using to connect to the network. Suppose, for example, that user A has subscribed to a particular gaming service and has authorized his friends (users B, C and D) to obtain his USC information. Suppose that when user B connects to the network, user A is currently connected to the network via a cell phone which does not enable user A to use that particular gaming service. Nonetheless, user B is able to determine that user A has subscribed to that gaming service by, e.g., checking his or her address book on one of user B's devices which has received user A's USC information from, e.g., a CAB server, so that user B will then know to contact user A to set up a gaming session. Similarly, suppose that when user C connects to the network, user A is not connected to the network at all (e.g., significantly different time zones). Still, user C will be alerted to user A's subscription to this gaming service by using his or her address book, since the notification is independent of user A's presence on the network.

The above-described exemplary embodiments are intended to be illustrative in all respects, rather than restrictive, of the present invention. Thus the present invention is capable of many variations in detailed implementation that can be derived from the description contained herein by a person skilled in the art. All such variations and modifications are considered to be within the scope and spirit of the present invention as defined by the following claims. No element, act, or instruction used in the description of the present application should be construed as critical or essential to the invention unless explicitly described as such. Also, as used herein, the article “a” is intended to include one or more items.

1. A Converged Address Book (CAB) network node comprising:
at least one processor configured to execute a CAB application;
at least one memory device connected to said at least one processor and configured to store CAB Personal Contact Cards (PCCs), each PCC being associated with a different user and having a plurality of Contact Views associated therewith;
wherein one of said Contact Views lists user service capabilities (USCs).

2. The CAB network node of claim 1, wherein said CAB application includes an eXtensible Markup Language Data Management (XDM) Enabler.

3. The CAB network node of claim 1, further comprising:
an interface toward a data repository in which information associated with said USCs can be obtained.

4. The CAB network node of claim 3, wherein said data repository is one of a Home Location Register (HLR) and a Home Subscriber Server (HSS).

5. The CAB network node of claim 1, wherein said USCs are independent of device service capabilities (DSCs) associated with user equipment via which a first user connects to a communication network.

6. The CAB network node of claim 1, wherein said USCs identify services that are available in a communication network via which a given user can be contacted by other users including all of those services to which said first user has subscribed.

7. The CAB network node of claim 3, wherein said at least one processor is further configured to translate said information retrieved from said data repository into said USCs in said list.

8. A method for providing Converged Address Book (CAB) information to users of a communications network comprising:
storing a plurality of Personal Contact Cards (PCC), each PCC being associated with a different user and having a plurality of Contact Views associated therewith,
wherein one of said Contact Views lists user service capabilities (USCs); and
transmitting said USCs to said users.

9. The method of claim 8, wherein said USCs are independent of device service capabilities (DSCs) associated with user equipment via which a user connects to a communication network.

10. The method of claim 8, wherein said USCs identify services that are available in a communication network via which a given user can be contacted by other users including all of those services to which said first user has subscribed.

11. The method of claim 8, further comprising:
retrieving information from a data repository; and
translating said information into said USCs prior to storing said USCs in said one of said Contact Views.

12. The method of claim 8, wherein said step of transmitting further comprises:
selectively transmitting said USCs to users which are authorized by a user corresponding to said PCC.

13. A method for exchanging service capabilities in a communication network, comprising:
transmitting, from a network node, user service capabilities (USC) information, which USC information indicates those services that are available in said communication network via which a first user can be contacted by other users.

14. The method of claim 13, wherein said USC information is independent of device service capabilities (DSC) associated with user equipment via which said first user connects to said communication network.

15. The method of claim 13, wherein said services that are available in said communication network via which said first user can be contacted by other users includes all of those services to which said first user has subscribed.

16. The method of claim 13, wherein said step of transmitting further comprises:
transmitting said USC information only to users that have been authorized to receive said USC information by said first user.

17. The method of claim 13, wherein said network node is an address book application server node and further comprising:
receiving, by said address book application server node, said USC information from a data repository associated with said communication network.

18. The method of claim 17, wherein said data repository is one of a Home Location Register (HLR) and a Home Subscriber Server (HSS).

19. The method of claim 17, further comprising the steps of:
mapping said USC information from a source format in which it is stored in said data repository into a second format.

20. The CAB network node of claim 3, wherein said one of said Contact Views lists user service capabilities (USCs) in additional data fields within the Contact View of the PCC, which additional data fields are stored in the data repository after being mapped into another format.

21. The method of claim 8, further comprising the step of:
storing additional data fields within the Contact View of the PCC after mapping said additional data fields into another format.
